(19) United States
(12) Patent Application Publication
(10) Pub. No.: US 2019/0316463 A1
(43) Pub. Date: Oct. 17, 2019

(54) WELL-DRILLING DATA COMMUNICATION AND PROCESSING TOOL

(71) Applicant: Aelium Solutions LLC, Magnolia, TX (US)

(72) Inventors: Jochen Pfrenger, The Woodlands, TX (US); Ron Roling, The Woodlands, TX (US)

(73) Assignee: Aelium Solutions LLC, Magnolia, TX (US)

(21) Appl. No.: 16/385,771

(22) Filed: Apr. 16, 2019

Related U.S. Application Data
(60) Provisional application No. 62/658,711, filed on Apr. 17, 2018.

(51) Int. Cl. E21B 47/12; E21B 3/02; G06K 19/07

(52) U.S. Cl. CPC E21B 47/122; G06K 19/0723; E21B 3/02

(57) ABSTRACT

A well-drilling system comprises a tubular string, a torque sub system, and one or more downhole devices. The tubular string extends into the well bore and comprises at least one of a radio-frequency device and a communication line. The one or more downhole devices are attached to the tubular string and collect data and transmit signals representative of the data to the torque sub system. The torque sub system is configured to communicate with one or more downhole devices and to transmit the data from the downhole devices to a computing device. The torque sub system is configured to communicate with the at least one of the radio-frequency device and the communication line. The torque sub system is configured to communicate with the down hole devices via the communication line. The torque sub system is configured to measure acceleration, vibration, and displacement data and to transmit that data to the computing device. The torque sub system is configured to measure, record and transmit acceleration, vibration, and displacement data and to transmit that data to the downhole devices.

### RELATED APPLICATIONS

The present application is a non-provisional patent application and claims priority benefit, with regard to all common subject matter, of earlier-filed U.S. provisional patent application titled “DATA COMMUNICATION AND) PROCESSING TOOL”, Ser. No. 62/658,711, filed on Apr. 17, 2018, which is incorporated by reference in its entirety into the present application.

### BACKGROUND

Well-drilling systems drill deep into the surface of the earth for extracting various resources, such as water, oil, gas, geothermal energy, etc. The systems often encounter a multitude of obstacles, including rocks or other geological impediments. Well-drilling systems may also experience equipment malfunctions and/or failures. Because such obstacles and malfunctions often occur deep in the earth's surface, determining the nature of a particular obstacle and/or malfunction is very difficult and often involves a lot of guesswork, which can delay completion of a project and result in additional losses.

The background discussion is intended to provide information related to the present invention which is not necessarily prior art.

### SUMMARY

The present invention solves the above-described problems and other problems and provides an improved well-drilling system that enables gathering real-time data and/or near-real-time data about drilling and/or casing operations to detect and avoid obstacles, detect and prevent equipment malfunctions, and to make real-time adjustments to operations based on the data.

A well-drilling system constructed in accordance with an embodiment of the present invention broadly comprises a tubular string, a downhole device, and a torque sub system. The downhole device is attached to the tubular string and is configured to transmit one or more signals representative of parameters during a drilling operation, a casing running operation, or a tubular make-up and break-out operation. The torque sub system is positioned above the tubular string and in communication with the downhole device and configured to receive the one or more signals from the downhole device and transmit the one or more signals to a computing device. This arrangement enables the torque sub system to measure or otherwise monitor any drilling parameter, tubular make-up parameter, tubular break-out parameter, including internal fluid pressures and/or information about a tubular. It also allows for communication between any downhole devices and the torque sub system and allows for relaying data through the tubular string. This enables gathering of more accurate data and additional types of data to be collected. The data may then be processed locally or remotely to provide real-time solutions to overcoming and/or avoiding drilling obstacles and malfunctions. Additionally, the arrangement enables correlating data collected downhole with data collected by the torque sub system for determining signatures in the topside-collected data that correspond to specific events downhole.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic view of an exemplary well-drilling system constructed in accordance with embodiments of the invention;

FIG. 2 is a perspective view of the well-drilling system of FIG. 1;

FIG. 3 is a perspective view of a tubular of the well-drilling system of FIG. 2;

FIG. 4 is a perspective view of the well-drilling system of FIG. 2 in various configurations;

FIG. 5 is a schematic view of a torque sub system of the well-drilling system of FIG. 1 in various configurations;

FIG. 6 is a schematic view of the torque sub system of FIG. 5;

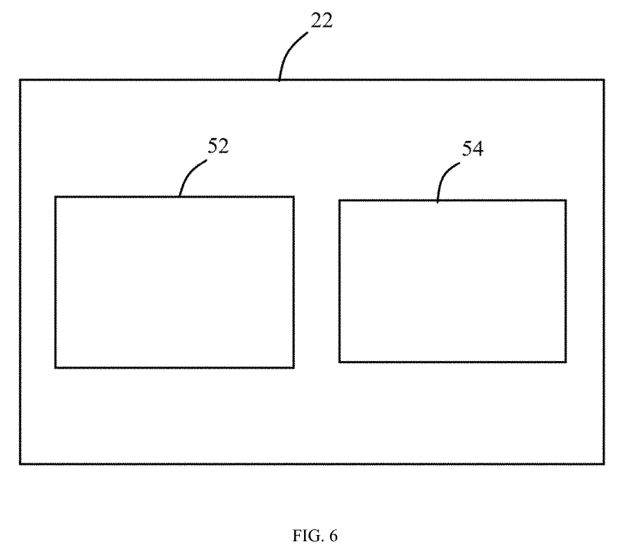

FIG. 7 is a schematic view of the communication paths of the well-drilling system of FIG. 1;

FIG. 8 is a schematic view of the communication paths of the well-drilling system of FIG. 1 with an access point;

FIG. 9 is a schematic view of the communication paths of the well-drilling system of FIG. 1 with the access point wirelessly communicating; and

FIG. 10 is a schematic view of the communication paths of the well-drilling system of FIG. 1 with a data gateway.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

The drilling industry is becoming more data-driven every year with the advancements of communication technologies, sensors, “smart” sensors, machine learning, artificial intelligence, advanced data processing capabilities, cloud computing, edge computing, and data communication and processing tools. For example, a torque sub system providing improved data-collection capabilities is described in related U.S. provisional patent applications titled, “INTEGRATED VALVE-SENSOR SYSTEM WITH DATA PROCESSING”, Ser. No. 62/619,244 and tiled Jan. 19, 2018; U.S. provisional patent application titled, “INTEGRATED VALVE-SENSOR SYSTEM WITH DATA PROCESSING”, Ser. No. 62/565,685 and filed Sep. 29, 2017; and U.S. non-provisional patent application titled “WELL DRILLING SYSTEM” Ser. No. 16/137,804 and filed Sep. 21, 2018, all three of which are incorporated by reference. Additionally, significant advancements are being made in downhole smart tools and applications for recording downhole data and transmitting that data to the surface (typically a drilling rig) for recording, analysis, process automation, and optimization.

Additional data may be communicated from the drilling rig into the wellbore to downhole tools and sensors via the torque sub system and with embodiments of the present invention. The present invention also improves the use of RFID and similar asset identification and management technologies for drilling and tubular running operations.

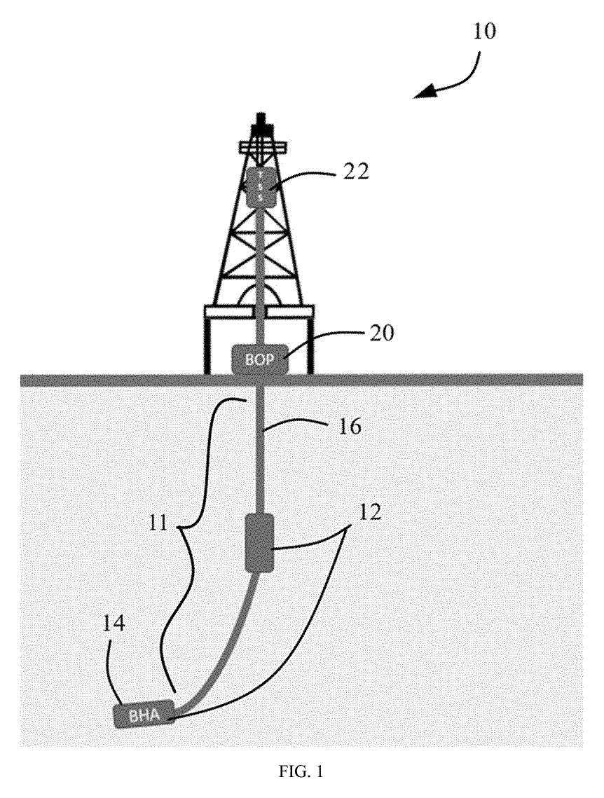

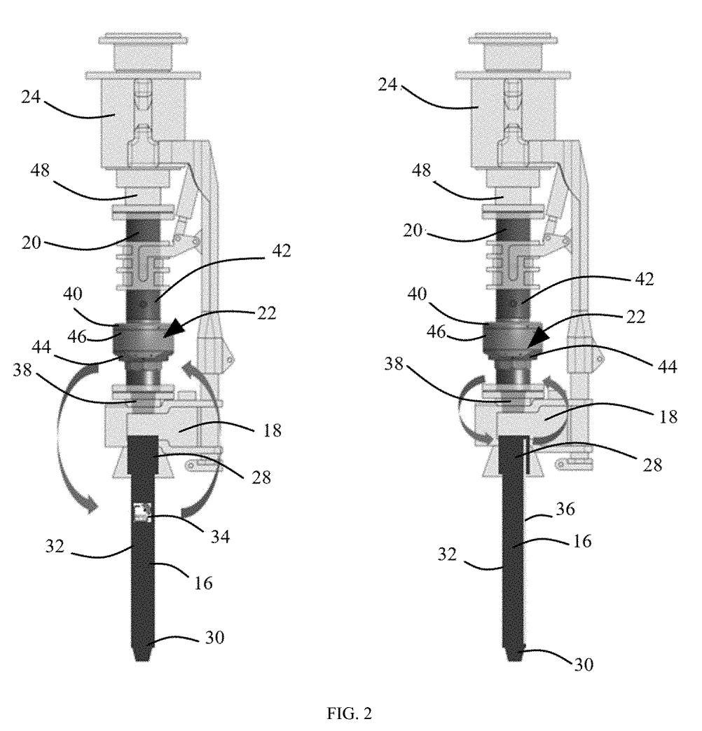

Turning to FIG. 1, a well-drilling system 10 constructed in accordance with an embodiment of the present invention is illustrated. The well-drilling system 10 may be used for any drilling application, including drilling for water, oil, gas, geothermal energy, etc. The well-drilling system 10 may be positioned on any type of rig, including rigs on land or offshore. The well-drilling system 10 may comprise a tubular string 11 having a plurality of tubulars 16, one or more downhole devices 12, a bottom hole assembly (BHA) 14, a back-up clamp assembly 18, a blow-out preventer valve module 20, a torque drive system 24, and a torque sub system 22, as depicted in FIGS. 1 and 2.

The one or more downhole devices 12 may be attached to the tubular string 11 and/or other components attached to the tubular string 11. The downhole devices 12 may also be attached at different locations along the well bore. The downhole devices 12 may comprise any number of devices, including transceivers, sensors, cameras, microphones, repeaters, etc. and can be positioned along the tubular string 11 and/or the well bore and provide data or relay data concerning operation. The data may be real-time data or near-real-time data. The downhole devices 12 may be in communication with the torque sub system 22 via wireless communication, via one or more radio-frequency devices of the tubulars 16 (discussed below), and/or via one or more communication lines (discussed below) of the tubulars 16 in the tubular string 11.

The bottom hole assembly (BRA) 14 may be attached to an end of the tubular string 11 and may also include a downhole device 12 configured to transmit signals representative of data gathered during the operation of the BHA 14 and/or other data. The BHA 14 may comprise a drill bit, a motor, and a wide array of possible sensors and steering means. The downhole device 12 of the BHA 14 may also be in communication with the torque sub system 22 via wireless communication and/or via one or more communication lines (discussed below) in the tubulars 16 of the tubular string 11.

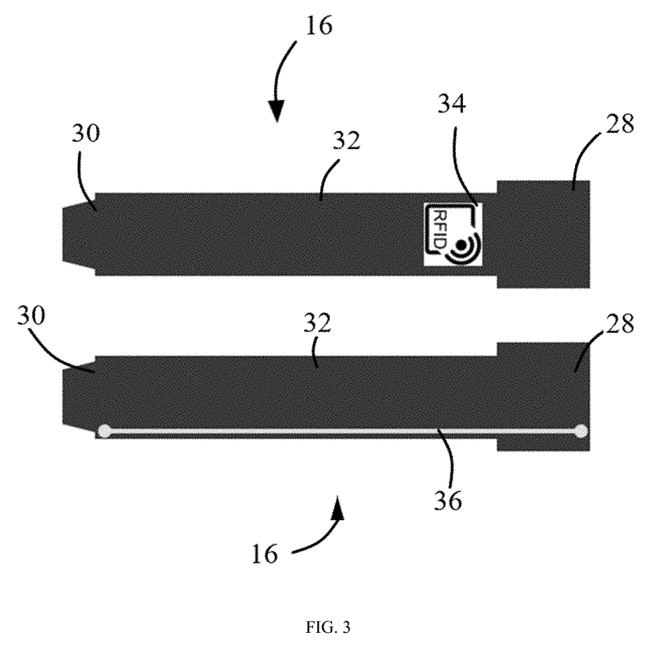

Turning to FIG. 3, each tubular 16 in the tubular string 11 may comprise a first end 28, a second end 30, and a body portion 32. The tubulars 16 may be drillpipes or casings. A radio-frequency device 34 and/or a communication line 36 may be embedded in and/or attached to the body portion 32 of each tubular 16. The radio-frequency device 34 may be a radio-frequency identification (RFID) tag that emits an electromagnetic response that is associated with information about the tubular 16 to which it is attached. The radio-frequency device 34 may also be a transmitter, receiver, or transceiver, such as a Bluetooth® device, a Bluetooth® low energy device, or the like. The communication line 36 may extend from the first end 28 to the second end 30 so that signals are passed along the tubulars 16 having communication lines 36. The communication line 36 may be a wire, fiber optic cable, or the like.

Turning back to FIG. 2, the radio-frequency device 34 and/or the communication line 36 of the first tubular 16 are configured to pass signals to the torque sub system 22, as indicated by the arrows. The signals may be from the downhole devices 12, including downhole devices 12 on or near the BHA 14 and may be representative of data gathered by sensors and other devices downhole. The signals may be data representative of information about one or more of the tubulars 16, including a length of the tubular, a weight of the tubular, a torque limit of the tubular, a composition type of the tubular, a pipe grade of the tubular, a pipe type of the tubular, a pipe range of the tubular, inspection data of the tubular, connection type of the tubular, make-up or break-out data of the tubular, a number of times the tubular has been used, life cycle data of the tubular, and/or fatigue data of the tubular, or the like.

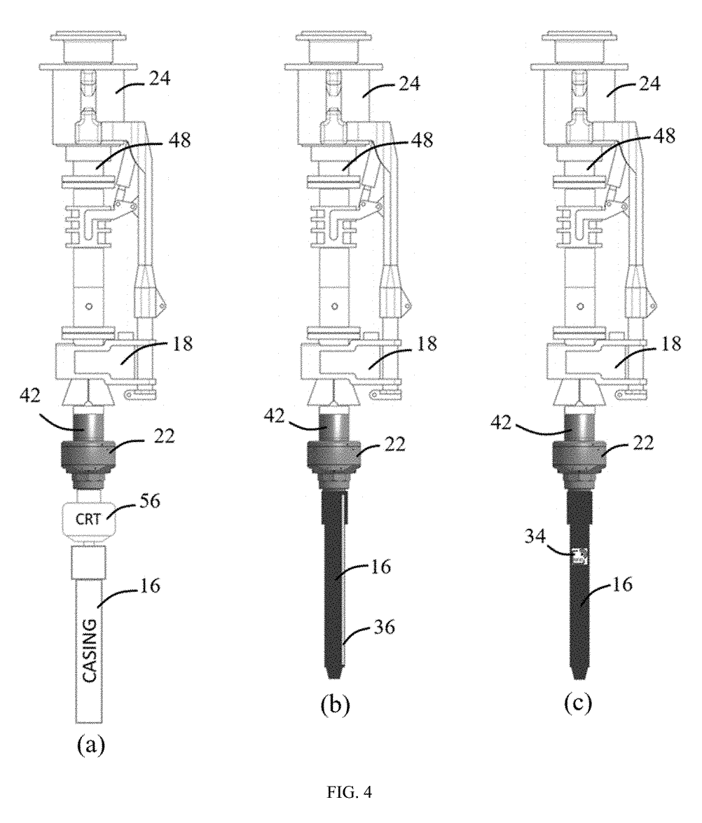

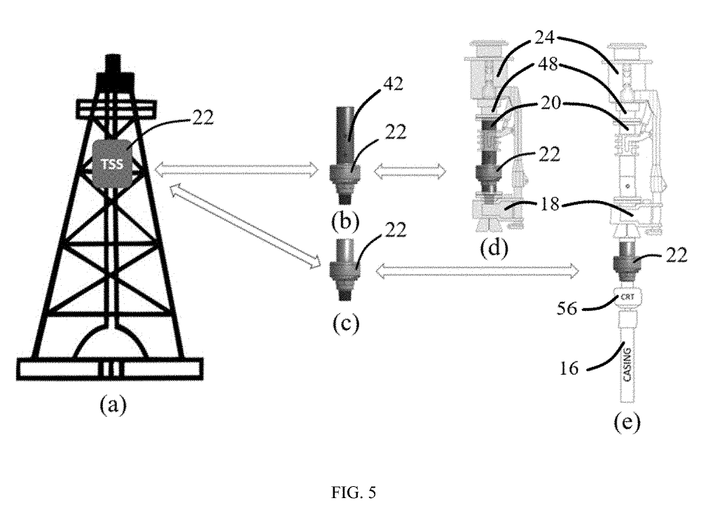

The back-up clamp assembly 18 is positioned above the tubular 16 and couples with and supports the first end 28 of the tubular 16. The back-up clamp assembly 18 may be part of a larger pipe handler assembly and may be positioned below the blow-out preventer valve module 20 and the torque sub system 22. In some embodiments, the back-up clamp assembly 18 is positioned above the torque sub system 22, as shown in FIGS. 4 and 5. In some embodiments, the back-up clamp assembly 18 secures a saver sub 38, which may be used to cross-over from the torque sub system 22 to the tubular 16. The saver sub 38 protects the threaded connection of the torque sub system 22 and allows connection cross-over from the torque sub system 22 connection to a specific tubular 16 in the tubular string 11.

The blow-out preventer valve module 20 is positioned between the torque drive system 24 and the back-up clamp assembly 18, as shown in FIG. 2. The blow-out preventer valve module 20 functions to isolate pressure in the tubular string 11 should a high-pressure situation inside of the tubular string 11 occur. In addition, the blow-out preventer valve module 20 can be used as a “mud saver”. The blow-out preventer valve module 20 may be engaged by the torque drive system 24. The blow-out preventer valve module 20 may comprise ball-type valves or any other type of fluid-regulating valves.

The torque drive system 24 may be a top drive system or any other system or device capable of rotating the tubular 16/tubular string 11 and its associated drill bit. As illustrated in FIGS. 2 and 4, an embodiment of the torque drive system 24 includes a rotating shaft 48.

The torque sub system 22 measures or otherwise monitors drilling parameters and/or tubular make-up and break-out parameters such as the torque and speed exerted on the drill bit of the well-drilling system 10, internal fluid pressures in the tubular string 11, tubular string 11 temperature, vibration, and tension and compression. The torque sub system 22 may be in communication with the radio-frequency device 34, the communication line 36, and/or the downhole devices 12 and is configured to transmit one or more signals to a computing device 50. The torque sub system 22 may be positioned above the drill floor of the well-drilling system 10. The torque sub system 22 may be attached to the torque drive system 24, integrated with the torque drive system 24 and/or the casing running tool 56, or positioned between the blow out preventer valve module 20 and the back-up clamp assembly 18 (as depicted in FIGS. 2 and 5(d)), between the back-up clamp assembly 18 and a casing running tool 56 (as depicted in FIGS. 4(a) and 5(e)), between the back-up clamp assembly 18 and the first tubular 16 (as depicted in FIGS. 4(b) and 4(c)), or even below the casing running tool 56. The torque sub system 22 may include a housing 40, a sub body 42, a topside communication device 52, and one or more sensors 54.

The housing 40 may be comprised of a lower housing 44 and an upper housing 46 that enclose and protect the topside communication device 52 and the sensors 54. Additionally or alternatively, the topside communication device 52 and/or the sensors 54 may be mounted on the sub body 42.

The upper end of the sub body 42 may be threaded for engaging complimentary threads on the lower end of the blow-out preventer valve module 20 or the rotating shaft 48 of the torque drive system 24. The lower end of the sub body 42 may be threaded for engaging complimentary threads on the saver sub 38. Because the torque sub system 22 may be connected below the blow-out preventer valve module 20 and above the back-up clamp assembly 18 and tubular 16, the saver sub 38 may be used to make or break tubular string 11 connections without modifying or otherwise interfering with the blow-out preventer valve module 20 and the torque sub system 22. This configuration also permits the torque sub system 22 to measure drilling parameters and/or tubular make-up and break-out parameters below the blow-out preventer valve module 20 so that parameters such as internal fluid pressures may be monitored even when the blow-out preventer valve module 20 is closed.

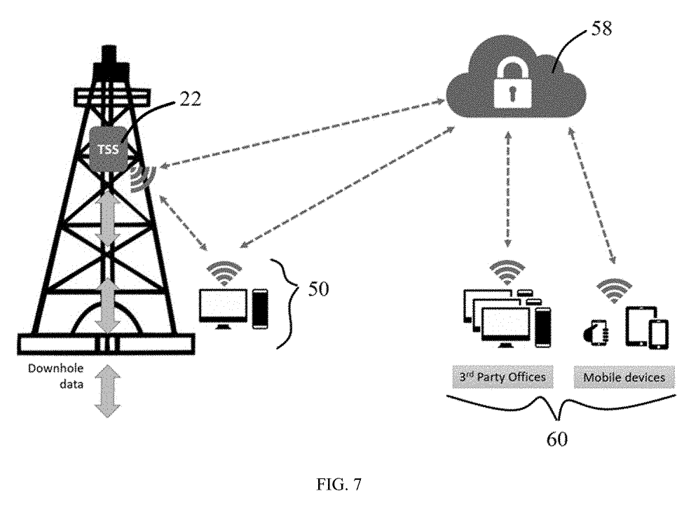

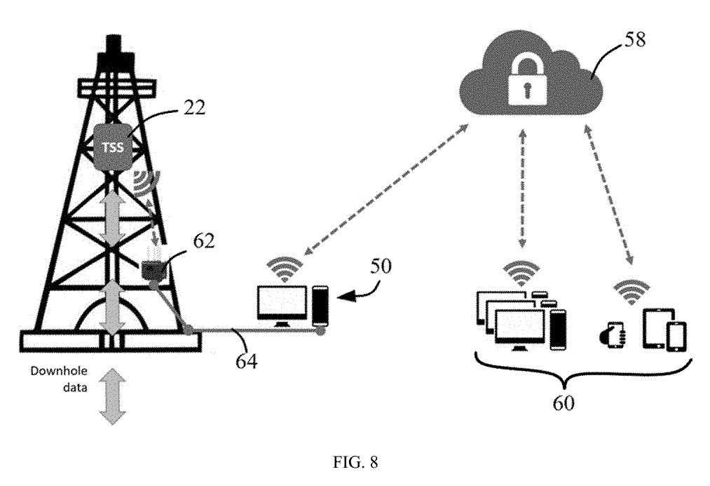

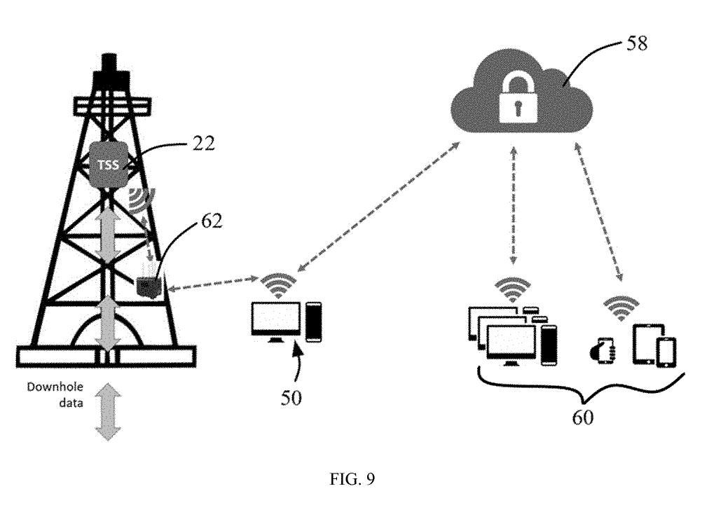

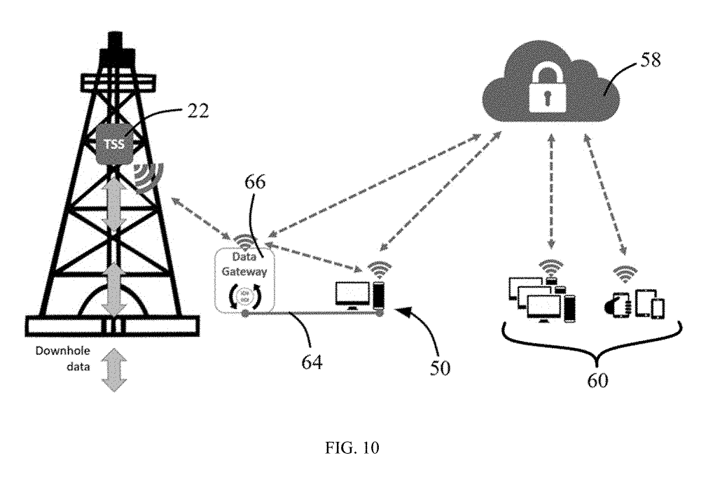

The topside communication device 52 may be configured to communicate mono-directionally, hi-directionally, and/or multi-directionally. The topside communication device 52 may receive signals representative of data of various operating parameters from the radio-frequency device 34, the communication line 36, the downhole devices 12, and/or the one or more sensors 54. The topside communication device 52 may be configured to transmit one or more of the signals to the computing device 50. The computing device 50 may be a personal computer, tablet, or other device on the drilling rig, such as a driller's control device, which may transmit the data to the cloud 58 and/or additional computing devices 60, as depicted in FIGS. 7-10. Additionally or alternatively, the topside communication device 52 may transmit one or more signals to an access point 62 having a communication line 64 connected to the computing device 50, as depicted in FIG. 8. The access point 62 may additionally or alternatively include wireless communication capabilities so that it wirelessly transmits data to the computing device 50, as depicted in FIG. 9. Additionally or alternatively, the topside communication device 52 may communicate with a data gateway 66, which may communicate with the computing device 50 and/or the cloud 58, as shown in FIG. 10.

The one or more sensors 54 of the torque sub system 22 may include a torque sensor, a tension/compression sensor, a vibration sensor, a temperature sensor, a drilling fluid pressure sensor, an acceleration sensor, a resonance sensor, a speed sensor, a drilling fluid flow sensor, a displacement sensor, a drilling fluid level sensor, a vibration and/or acceleration sensor, and/or other measurement technologies for detecting acceleration, displacement, and/or vibration of the torque sub system 22. These are merely examples of sensors that may be used with the present invention. Additional sensors that are useful in well-drilling operations and related fields may be incorporated without departing from the scope of the present invention. Data generated by the one or more sensors 54, which is generated from topside measurements, can be correlated to events taking place downhole (i.e. stick-slip, bit whirl, bit bounce, kick detection, etc.) and which may be detected and measured by downhole devices 12. The data can then be used and analyzed to automate and optimize the drilling or tubular running processes. The correlated data enables measuring only topside data via the torque sub system 22 in order to obviate complex and costly downhole data measuring and communication devices 12.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A well-drilling system comprising:
a tubular string;
a downhole device attached to the tubular string and configured to transmit one or more signals representative of data collected downhole; and
a torque sub system positioned above the tubular string and configured to receive the one or more signals from the downhole device and transmit one or more signals to the downhole device.

2. The well-drilling system of claim 1, wherein the tubular string comprises a first tubular having a first end, a second end, and a radio-frequency device, and wherein the torque sub system is configured to detect the radio-frequency device.

3. The well-drilling system of claims wherein the radio-frequency device is an RFID tag.

4. The well-drilling system of claim 2, wherein the radio-frequency device is a transmitter configured to transmit signals to the torque sub system.

5. The well-drilling system of claim 1, wherein the tubular string comprises a first tubular having a first end, a second end, and a communication line extending from the first end to the second end for passing signals to the torque sub system from a second tubular connected to the second end of the first tubular.

6. The well-drilling system of claim 5, wherein the downhole device is configured to communicate with the torque sub system via the communication line.

7. The well-drilling system of claim 1, the torque sub system including one or more sensor configured to sense at least one of an acceleration of the torque sub system, a displacement of the torque sub system, and a vibration of the torque sub system and generate corresponding data.

8. The well-drilling system of claim 1, wherein the torque sub system is connected to the tubular string.

9. A well-drilling system comprising:
a first tubular having a first end and a second end; and
a torque sub system positioned above the first tubular and having one or more sensors configured to sense at least one of a vibration of the torque sub system, an acceleration of the torque sub system, and a displacement of the torque sub system and generate corresponding data.

10. The well-drilling system of claim 9, wherein the torque sub system is connected to the first tubular.

11. The well-drilling system of claim 9, further comprising a torque drive system configured to cause the first tubular to rotate, wherein the torque sub system is connected to the torque drive system.

12. The well-drilling system of claim 9, further comprising a casing running tool engaged with the first end of the first tubular, wherein the torque sub system is connected to the casing running tool.

13. The well-drilling system of claim 9, further comprising a downhole device configured to transmit data collected downhole to the torque sub system.

14. The well-drilling system of claim 13, wherein the torque sub system is configured to transmit the data from the one or more sensors in association with the data collected downhole to a computing device.

15. The well-drilling system of claim 9, further comprising a downhole device, wherein the torque sub system transmits at least one of a vibration of the torque sub system and an acceleration of the torque sub system to the downhole device.

16. A well-drilling system comprising:
a tubular string comprising a first tubular having at least one of a radio-frequency device and a communication line; and
a torque sub system positioned above the first tubular and configured to receive information from the at least one of the radio-frequency device and the communication line.

17. The well-drilling system of claim 16, wherein the radio-frequency device is an RFID chip.

18. The well-drilling system of claim 16, wherein the radio-frequency device is a transmitter configured to transmit signals to the torque sub system.

19. The well-drilling system of claim 16, further comprising a downhole device in communication with the communication line and configured to pass signals to the torque sub system via the communication line.

20. The well-drilling system of claim 16, wherein the radio-frequency device is associated with at least one of a length of the first tubular, a weight of the first tubular, a torque limit of the first tubular, a composition type of the first tubular, a pipe grade of the first tubular, a pipe type of the first tubular, a pipe range of the first tubular, inspection data of the first tubular, connection type of the first tubular, make-up or break-out data of the first tubular, a number of times the first tubular has been used, life cycle data of the first tubular, and fatigue data of the first tubular.
